(19) United States
(12) Patent Application Publication
(10) Pub. No.: US 2006/0146993 A1
(43) Pub. Date: Jul. 6, 2006

(54) Method and apparatus for enabling native language support preferences in a network

(76) Inventors: Marian Croak, Fair Haven, NJ (US); Hossein Eslambolchi, Los Altos Hills, CA (US)

Correspondence Address: Mr. S.H. Dworetsky;AT&T Corp., Room 2A-207, One AT&T Way, Bedminster, NJ, 07921, US

(21) Appl. No.: 11/017,023

(22) Filed: Dec. 20, 2004

(51) Int. Cl. H04M 1/64

(52) U.S. Cl. 379/88.05

(57) ABSTRACT

The present invention enables service providers, e.g., VoIP service providers, to offer users the ability to register their native language with a network based service so that all network announcements, network prompts, and network service features can be provided in the user's native language. This provisioned parameter can be entered and stored in the network on a default basis or placed into the signaling messages on a per call basis.

The present invention relates generally to communication networks and, more particularly, to a method and apparatus for enabling native language support preferences in a packet-switched network, e.g., a Voice over Internet Protocol (VoIP) network.

### BACKGROUND OF THE INVENTION

As the US becomes more diversified, the ability for service providers to offer features in multiple languages has become more critical to gain competitive advantages and to attract customers whose native language is not English. Therefore, a need exists for a method and apparatus for enabling native language support preferences in a packet-switched network, e.g.,-a Voice over Internet Protocol (VoIP) network.

### SUMMARY OF THE INVENTION

In one embodiment, the present invention enables service providers, e.g., VoIP service providers to offer users the ability to register their native language with a network based service so that all network announcements, network prompts, and network service features can be provided in the user's native language. This provisioned parameter can be entered and stored in the network on a default basis or placed into the signaling messages on a per call basis.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of enabling native language support preference in a VoIP network of the present invention;

FIG. 3 illustrates a flowchart of a method for registering native language support preference of the present invention;

FIG. 4 illustrates a flowchart of a method for enabling native language support preference of the present invention; and

FIG. 5 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

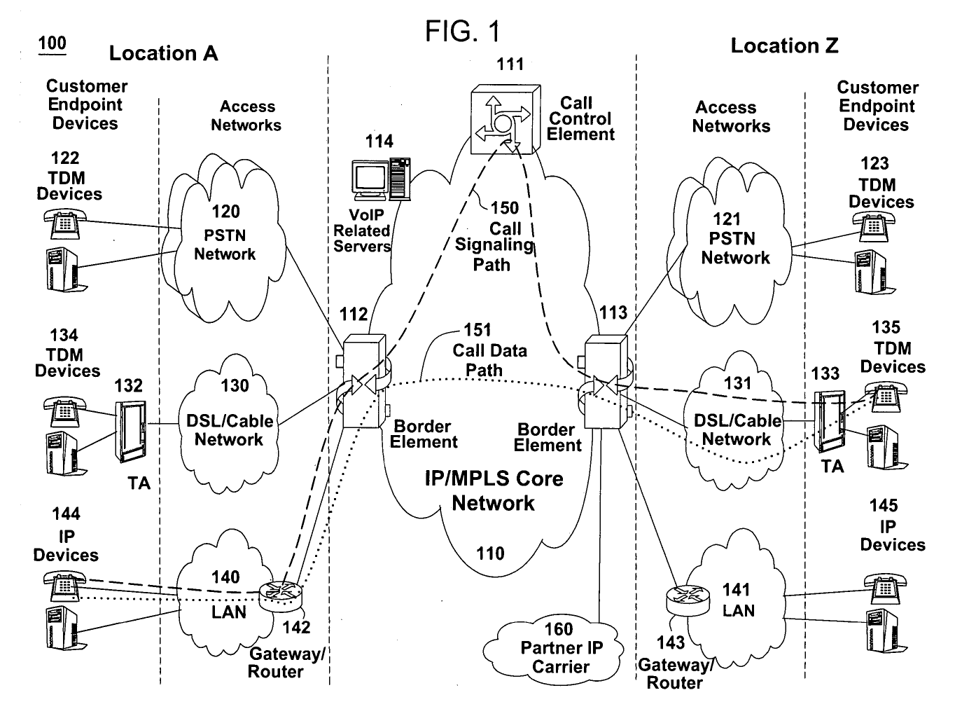

To better understand the present invention, FIG. 1 illustrates an example network, e.g., a packet-switched network such as a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

As the US becomes more diversified, the ability for service providers to offer features in multiple languages has become more critical to gain competitive advantages and to attract customers whose native language is not English. To address this need, the present invention enables VoIP service providers to offer users the ability to register their native language with a network based service so that all network announcements, network prompts, and network service features can be provided in the user's native language. This provisioned parameter can be entered and stored in the network on a default basis or placed into the signaling messages on a per call basis.

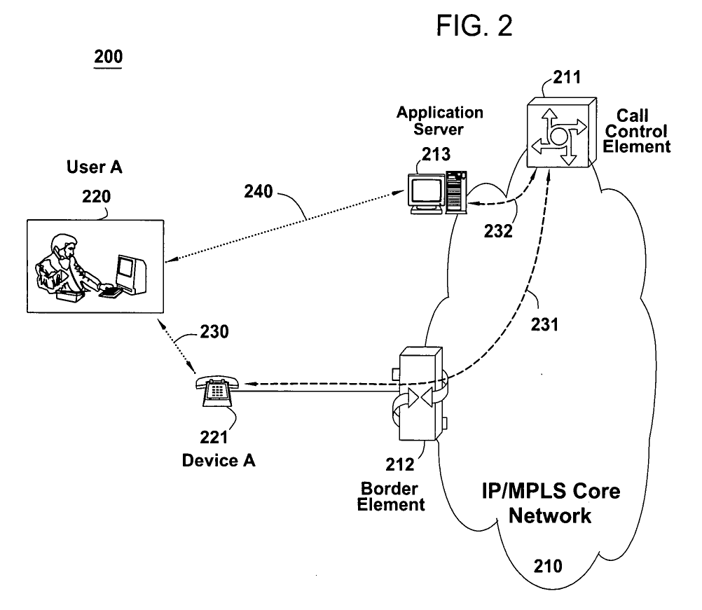

FIG. 2 illustrates an example of enabling native language support preference in a VoIP network. A subscriber 220, (e.g., user A), registers his native language preference either via a telephone interface 230 or a website interface 240 to enter and store the subscriber's default preference. It should be noted that registering the subscriber's preference is broadly defined to include registering the language reference for the subscriber's endpoint device, for the subscriber's phone number, for the subscriber's name, for the subscriber's IP address and the like. The network stores his native language preference in an Application Server (AS) 213 and the preference can be retrieved by the CCE 211 during call processing when needed.

When CCE 211 receives a call or call setup 231 originating from or destined to user A, who is a subscriber of the native language support service feature, the CCE checks if language support is necessary, flow 232, for that call. If the call requires native language support, the language preference will be retrieved from AS 213 by CCE 211 in order to process the call appropriately. For instance, for a call that the network needs to relay a network announcement to user A, the CCE 211 will use the user's default language preference, if the signaling indicates no other choice of language to be used. Namely, the network will relay the network announcement in the default language. In the case that if the signaling message of a call comprises a language preference selection, then CCE 211 will process the call requiring language support using the selected language indicated in the signaling message. If the selected language preference in a signaling message is different from the default language preference stored in the network, the language preference indicated in the signaling message will be used.

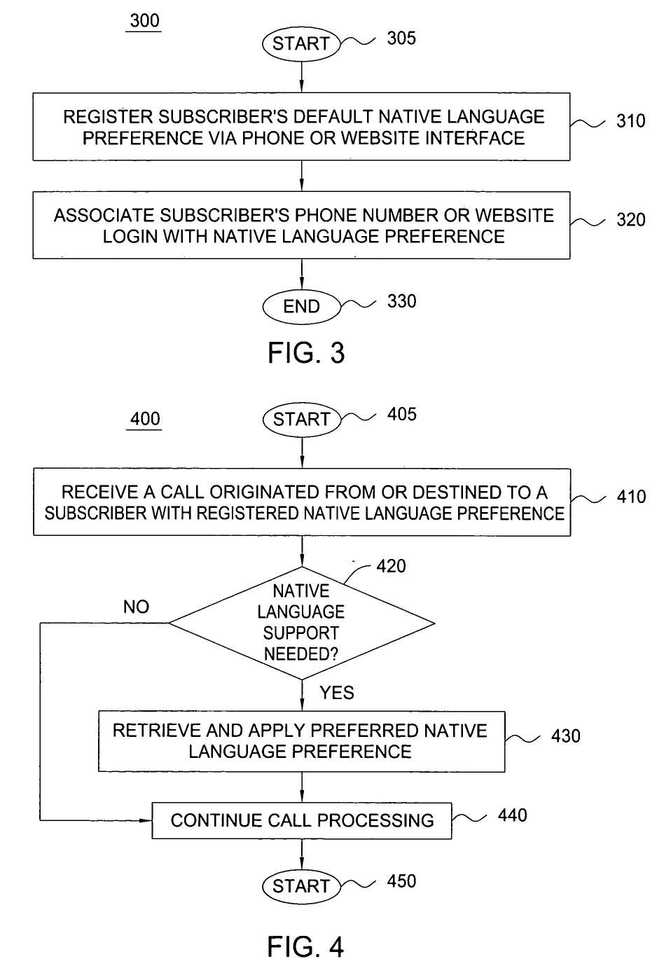

FIG. 3 illustrates a flowchart of a method 300 for registering native language support preference by the network. Method 300 starts in step 305 and proceeds to step 310.

In step 310, the method registers a subscriber's native language support preference either via a phone or website interface. For example, the subscriber can register Spanish, Chinese, Italian, German, Japanese, Russian, French, Portuguese and the like as the native language support preference.

In step 320, the method associates the default language preference with the subscriber's phone number and/or website login name. Method 300 ends in step 330.

FIG. 4 illustrates a flowchart of a method 400 for enabling native language support preference by the CCE. Method 400 starts in step 405 and proceeds to step 410.

In step 410, the method receives a call originated from or destined to a subscriber who has registered for native language support preference. In step 420, the method checks if the call requires language support features. If the call requires language support, the method proceeds to step 430; otherwise, the calls proceeds to step 440.

In step 430, the method retrieves the default native language preference of the user either from the AS that stores the user's native language preference or the signaling message if the native language preference selection is present. Then CCE 211 applies the selected native language to process the call.

In one embodiment, if the language preference (e.g., Spanish) in the signaling message is different than the user's default native language preference (e.g., English), then the network will apply the language preference (e.g., Spanish in this example) as specified in the signaling message. This situation may arise if on a per call basis, a current user (e.g., someone who does not speak English) of the endpoint device may be a friend or relative of the subscriber. As such, the present invention allows on a per call basis for a user to override the default native language preference.

Alternatively, an incoming call that contains a language preference (e.g., English) in the signaling message is different than the user's default native language preference (e.g., Spanish), then the network will apply the language preference (e.g., Spanish in this example) as specified in the user's default native language preference. This situation may arise from an organization who wants to contact the user in the manner most receptive to the user. If the user has a native language preference, then the calling party will want to accommodate that preference.

Returning to FIG. 4, in step 440, the method continues to process the call using the selected native language preference. If no selection is available from the user, the network uses the network default language to continue processing the call. The network default language is configurable by the network provider. Method 400 ends in step 450.

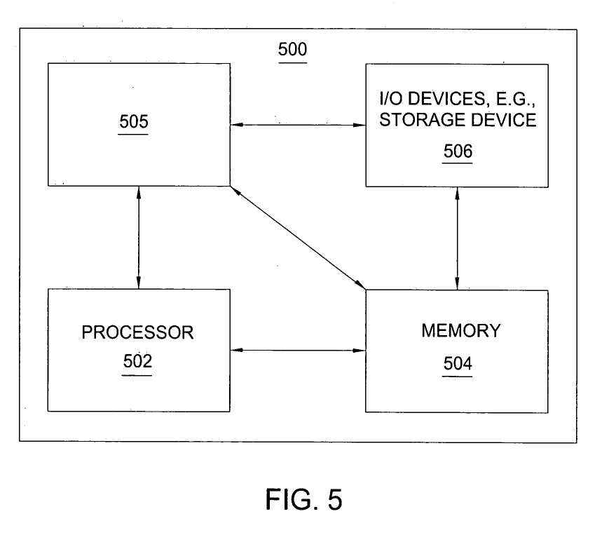

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM), a native language support module 505, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present native language support module or process 505 can be loaded into memory 504 and executed by processor 502 to implement the functions as discussed above. As such, the present native language support process 505 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for enabling language support preference in a communication network, comprising:
registering a native language support preference of a subscriber;
receiving a call setup from said subscriber or to said subscriber, where said call setup requires a language support; and
processing said call setup in accordance with said native language support preference or a selected language preference in said call setup.

2. The method of claim 1, wherein said communication network is a Voice over Internet Protocol (VoIP) network.

3. The method of claim 1, wherein said native language support preference is registered via a telephone or a website interface.

4. The method of claim 1, wherein said registering comprises:
associating said native language support preference with at least one of: at least one telephone number registered by said subscriber and at least one endpoint device.

5. The method of claim 1, wherein said call setup is processed by a call control element (CCE).

6. The method of claim 1, wherein said processing comprises:
retrieving said native language support preference stored in the network; and
using said native language support preference to process said call setup if said selected language preference in not specified in said call setup.

7. The method of claim 6, wherein said native language support preference is retrieved by a call control element (CCE) from an application server (AP).

8. The method of claim 1, wherein said processing comprises:
using said selected language preference instead of said native language support preference on a per call basis to process said call setup.

9. The method of claim 1, wherein said processing comprises:
using said native language support preference instead of said selected language preference in said call setup if said call setup is destined to said subscriber.

10. A computer-readable medium having stored thereon a plurality of instructions, the plurality of instructions including instructions which, when executed by a processor, cause the processor to perform the steps of a method for enabling language support preference in a communication network, comprising:
registering a native language support preference of a subscriber;
receiving a call setup from said subscriber or to said subscriber, where said call setup requires a language support; and
processing said call setup in accordance with said native language support preference or a selected language preference in said call setup.

11. The computer-readable medium of claim 10, wherein said communication network is a Voice over Internet Protocol (VoIP) network.

12. The computer-readable medium of claim 10, wherein said native language support preference is registered via a telephone or a website interface.

13. The computer-readable medium of claim 10, wherein said registering comprises:
associating said native language support preference with at least one of: at least one telephone number registered by said subscriber and at least one endpoint device.

14. The computer-readable medium of claim 10, wherein said call setup is processed by a call control element (CCE).

15. The computer-readable medium of claim 10, wherein said processing comprises:
retrieving said native language support preference stored in the network; and
using said native language support preference to process said call setup if said selected language preference in not specified in said call setup.

16. The computer-readable medium of claim 15, wherein said native language support preference is retrieved by a call control element (CCE) from an application server (AP).

17. The computer-readable medium of claim 10, wherein said processing comprises:
using said selected language preference instead of said native language support preference on a per call basis to process said call setup.

18. The computer-readable medium of claim 10, wherein said processing comprises:
using said native language support preference instead of said selected language preference in said call setup if said call setup is destined to said subscriber.

19. A system for enabling language support preference in a communication network, comprising:
means for registering a native language support preference of a subscriber;
means for receiving a call setup from said subscriber or to said subscriber, where said call setup requires a language support; and
means for processing said call setup in accordance with said native language support preference or a selected language preference in said call setup.

20. The system of claim 19, wherein said communication network is a Voice over Internet Protocol (VoIP) network.
